(19) United States
(12) Patent Application Publication
(10) Pub. No.: US 2016/0020663 A1
(43) Pub. Date: Jan. 21, 2016

(54) BEARING UNIT AND MOTOR

(71) Applicant: Shinano Kenshi Kabushiki Kaisha, Ueda-shi (JP)

(72) Inventors: Junki SATO, Ueda-shi (JP); Takeshi MIYASAKA, Ueda-shi (JP)

(21) Appl. No.: 14/801,174

(22) Filed: Jul. 16, 2015

(30) Foreign Application Priority Data
Jul. 17, 2014 (JP) 2014-146798

(51) Int. Cl. H02K 5/16; F16C 43/02; F16C 33/20

(52) U.S. Cl. CPC H02K 5/16; F16C 33/20; F16C 43/02

(57) ABSTRACT

The bearing unit comprises: a bearing housing, which is composed of resin, being formed into a cylindrical shape and having an outer periphery, on which a stator core will be integrally attached; a rotation stopper section being formed in an outer wall face of the bearing housing, the rotation stopper section being capable of fitting to the stator core so as to prohibit the stator core from rotating in a circumferential direction; and a retainer section being formed in the outer wall face of the bearing housing, the retainer section being formed by thermally deforming an outer wall section of the bearing housing to overlap an end face of the stator core so as to retain the stator core.

### CROSS-REFERENCE TO RELATED APPLICATION

This application is based upon and claims the benefit of priority of the prior Japanese Patent Application No. 2014-146798, filed on Jul. 17, 2014, and the entire contents of which are incorporated herein by reference.

### FIELD

The present invention relates to a bearing unit for rotatably holding, for example, a rotor, and a motor having the bearing unit.

### BACKGROUND

Conventionally, a rotor shaft is rotatably held by a bearing, and the bearing is attached to a stator by a stator housing. The bearing is provided in a cylindrical member of the stator housing to rotatably hold the rotor shaft, and a stator core is attached on an outer periphery of the cylindrical member.

The stator housing is composed of metal, e.g., brass, so that the stator housing can be easily cut and formed into various shapes. A sintered bearing is press-fitted into the stator housing composed of the metal, and the stator core is fixed on the outer periphery by an adhesive.

On the other hand, some stator housings are not composed of metal, e.g., brass, but composed of resin for reducing a production cost. To prevent a bearing from axially shifting with respect to the stator housing, a retainer is provided to one end of the stator housing. With this structure, the axial shift of the bearing can be prevented (see Document 1).

Further, in a motor capable of restraining variation of an inner diameter of a bearing holder composed of resin so as to securely fix a stator core, a projecting stripe of a bearing housing is fitted to a groove of the stator core so as to prevent rotation of the stator core, and an upper end of the bearing holder is partially heated and outwardly plastically deformed like a flange so as to axially retain the stator core (see Document 2).

### PRIOR ART DOCUMENTS

Document 1: Japanese Patent No. 5039491

Document 2: Japanese Laid-open Utility Model Publication No. 7-27812

### SUMMARY

However, in the stator housing composed of resin and disclosed in each of Documents 1 and 2, strain of the inner diameter is easily generated when the bearing is press-fitted, so a following step of rotary sizing is sometimes required. After press-fitting the bearing, the retainer prohibits only the axial shift of the stator core. So, by heat shock, etc., cracks will be generated in the stator housing composed of resin, and holding force between the stator housing and the press-fitted bearing will be weakened. Therefore, the stator core will be slightly displaced by rotation of the motor, and assembling accuracy of the stator core and the stator housing must be lowered.

In case of partially heating the bearing housing composed of resin to plastically deform as disclosed in Document 2, there is a possibility that a main body part of the bearing housing is melted. If the bearing housing is melted, insufficient strength of the bearing housing will be caused, and working efficiency of assembling will be lowered. Further, when covering the stator core with an insulator, a thickness of the deformed part will be varied, so mountability of the insulator will be lowered.

The present invention has been invented to solve the above described problems of the conventional technologies.

Accordingly, an object of the present invention to provide a bearing unit, in which rotation and axial shift of a stator core, with respect to a bearing housing composed of resin, can be prohibited and which can be efficiently assembled.

Another object is to provide a motor, which has said bearing unit and which can be efficiently assembled with low cost.

To achieve the objects, the present invention has following structures.

Namely, the bearing unit of the present invention comprises:

a bearing housing, which is composed of resin, being formed into a cylindrical shape and having an outer periphery, on which a stator core will be integrally attached;

a rotation stopper section being formed in an outer wall face of the bearing housing, the rotation stopper section being capable of fitting to the stator core so as to prohibit the stator core from rotating in a circumferential direction; and

a retainer section being formed in the outer wall face of the bearing housing, the retainer section being formed by thermally deforming an outer wall section of the bearing housing to overlap an end face of the stator core so as to retain the stator core.

With the above described structure, the stator core is fitted to the outer wall section, the rotation of the stator is prohibited by the rotation stopper section, and the outer wall section of the bearing housing, which acts as the retainer section, is thermally deformed to overlap the end face of the stator core, so that the stator core can be accurately assembled, without being press-fitted into the bearing housing, and correctly positioned in the radial direction and the circumferential direction. Further, no strain of an outer diameter of the bearing housing is generated, so that following steps, e.g., rotary sizing step, can be omitted. By employing the bearing housing composed of resin, a production cost of the bearing unit can be reduced.

Preferably, the retainer section is constituted by the outer wall section of the bearing housing, in which a concentric circular groove is formed in an outer edge part, and

the outer wall section is deformed, by heat caulking, so as to overlap the end face of the stator core.

By thermally deforming the outer wall section acting as the retainer section, a main body part of the bearing housing is not thermally deformed, so that strength reduction of the bearing housing can be prevented and the stator core can be assembled and retained at a predetermined position.

Note that, the heat caulking is a caulking manner using any heating means, e.g., heat plate, ultrasonic wave means, infrared ray means, induction means. By performing the heat caulking, the heat generated by the heating means deforms the bearing housing for caulking.

Preferably, a position of a bottom part of the circular groove, in an axial direction, is equal to or lower than that of the end face of the stator core.

With this structure, when thermally caulking the retainer section, the part of the outer wall section to be deformed is located at the position above the bottom part of the circular groove, so that the part of the outer wall section can be plastically deformed without melting the main body part of the bearing housing. Therefore, the deformed part of the outer wall section overlaps the end face of the stator core and retains the stator core. Further, since a size of the outer wall section to be plastically deformed is predetermined, mountability of an insulator to the stator core is not lowered.

Preferably, the rotation of the stator core is prohibited by fitting a projecting stripe, which is axially formed in the outer wall section of the bearing housing, in a recessed groove, which is formed in an inner circumferential face of the stator core.

With this structure, the stator core can be assembled, without press-fitting or adhering the stator core to the bearing housing, and the rotation of the stator core can be prohibited only by aligning the projecting stripe, which is axially formed in the outer wall section of the bearing housing, with the recessed groove, which is formed in the inner circumferential face of the stator core, and fitting the both to each other.

The motor of the present invention comprises:

the bearing unit of the present invention;

a stator core being attached on an outer periphery of the bearing housing;

a bearing section being attached in the bearing housing of the bearing unit; and

a rotor being rotatably held by the bearing section.

With this structure, the motor can be easily assembled, and a production cost of the motor can be reduced.

As described above, the bearing unit, in which rotation and axial shift of the stator core, with respect to the bearing housing composed of resin, can be prohibited and which can be accurately assembled, and the motor, which has the bearing unit and can be efficiently assembled and whose production cost can be reduced, can be provided by the present invention.

### BRIEF DESCRIPTION OF THE DRAWINGS

Embodiments of the present invention will now be described by way of examples and with reference to the accompanying drawings which are given by way of illustration only, and thus are not limitative of the present invention, and in which:

FIG. 1A is a plan view of a bearing unit;

FIG. 1B is a sectional view of the bearing unit taken along a line X-X shown in FIG. 1A;

FIG. 1C is an enlarged sectional view of a part G shown in FIG. 1B, in which heat caulking is not performed;

FIG. 1D is an enlarged sectional view of the part G, in which heat caulking has been performed;

FIG. 2A is a front view of a bearing housing;

FIG. 2B is a perspective view of the bearing housing seen from diagonally above;

FIG. 2C is a perspective view of the bearing housing seen from diagonally below;

FIG. 2D is a sectional view of the bearing housing taken along a line Y-Y shown in FIG. 2A;

FIG. 3A is an exploded front view of the bearing housing and a stator core;

FIG. 3B is an exploded perspective view of the bearing housing and the stator core;

FIG. 3C is a front view of the stator core;

FIG. 3D is a plan view of the stator core;

FIG. 4A is a plan view of a blower; and

FIG. 4B is a sectional view of the blower taken along a line S-S shown in FIG. 4A.

### DESCRIPTION OF THE EMBODIMENTS

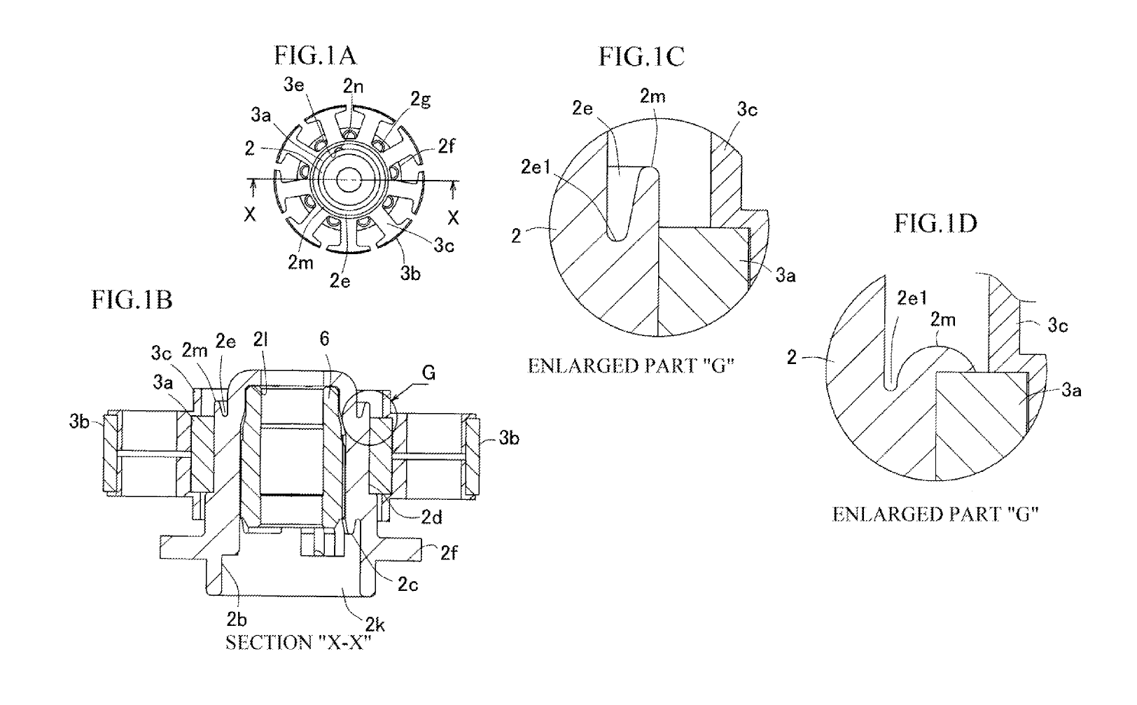

Preferred embodiments of the bearing section and the motor of the present invention will now be described in detail with reference to the accompanying drawings. Firstly, a schematic structure of a blower having a motor of the present invention will be explained, as an embodiment, with reference to FIGS. 1A-1D, FIGS. 2A-2D, FIGS. 3A-3D and FIGS. 4A-4B.

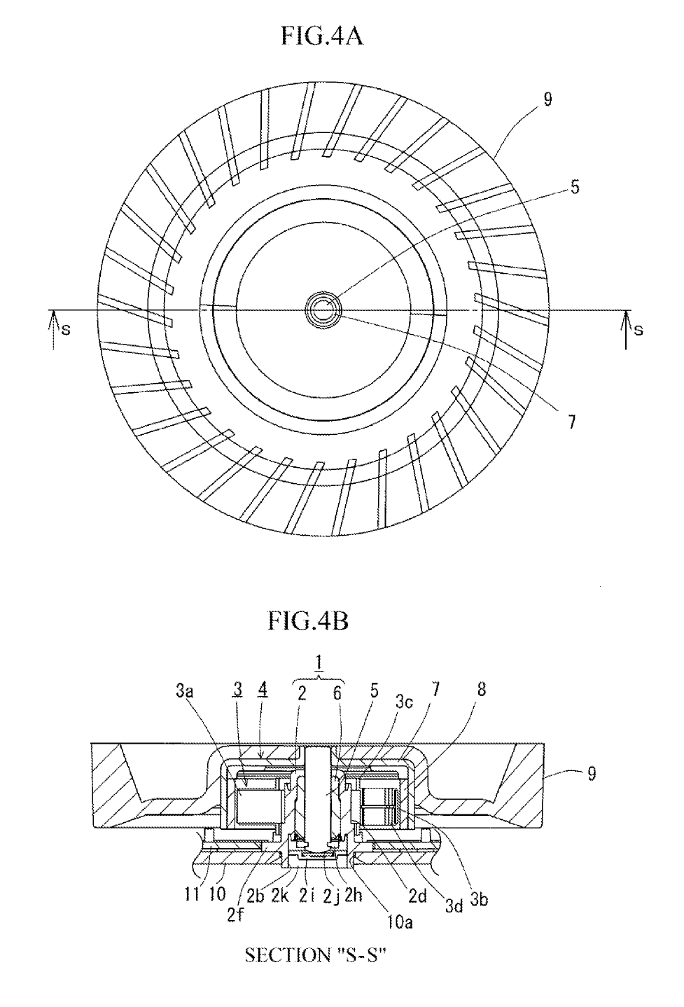

In FIGS. 4A and 4B, a stator 3 is attached on an outer circumferential face of a bearing housing 2 of a bearing unit 1. A rotor shaft 5 of a rotor 4 is fitted in a bearing section 6 composed of metal, which is attached in the bearing housing 2 composed of resin, and rotatably held therein. The resin forming the bearing housing 2 has superior dimensional accuracy and can be injection-molded. For example, the resin is poly phenylene sulfide (PPS) resin. The bearing section 6 is, for example, a slide bearing (oil-impregnated sintered bearing).

As shown in FIG. 4B, a rotor yoke 7 is integrated with one end part of the rotor shaft 5 by, for example, an adhesive, press fit, shrink fit, etc. The rotor yoke 7 is formed into a cup-shape having an opening part, and a ring-shaped rotor magnet 8 is fixed on an inner circumferential face of the rotor yoke 7. An impeller 9 is fitted on and integrated with an outer face of a top plate part of the rotor yoke 7 by press fit, an adhesive, etc. The impeller 4 shown in FIG. 4A generates vortex flow in a casing (not shown) of the blower so as to blow air.

As shown in FIG. 1B, the bearing unit 1 comprises: the bearing housing 2 being formed into a cylindrical shape and having a housing hole; and the metallic bearing section 6 being attached in the housing hole so as to rotatably hold the rotor shaft 5. For example, the metallic bearing section 6 (e.g., oil-impregnated sintered bearing) is fitted or lightly press-fitted in the bearing housing 2 composed of PPS resin. The oil-impregnated sintered bearing is produced by the steps of: mixing metallic materials; shaping the mixed material; sintering the shaped material; sizing the sintered bearing; and vacuum-impregnating oil into the sintered bearing, etc. An outer shape of the bearing section 6 has: a small diameter part, which is a front end part and fitted in the housing hole of the bearing housing 2; and a large diameter part, which is a rear end part and whose diameter is larger than that of the small diameter part. Note that, the bearing section 6 of the present embodiment has the different diameter parts as described above, but the diameter of the bearing section 6 may be entirely equal.

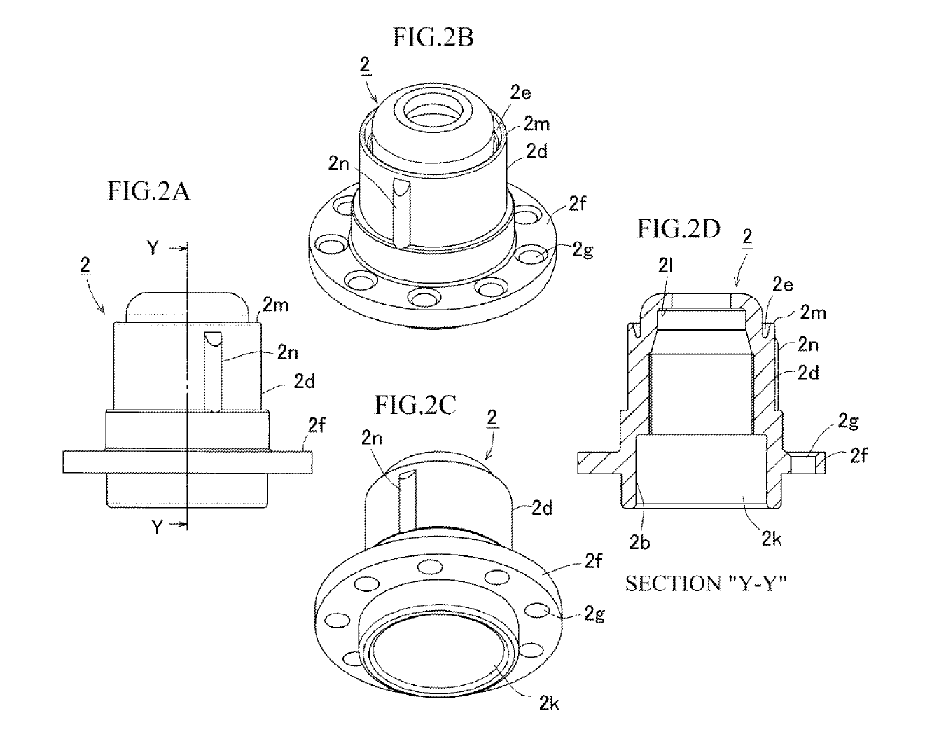

As shown in FIGS. 2A-2D, a step-shaped part 2d is formed in the outer wall face of the bearing housing 2. A stator core 3a is attached to the step-shaped part 2d (see FIG. 1B). In FIG. 1A and 1B, the stator core 3a has a plurality of pole teeth 3b, which are radially formed and covered with an insulator 3c. In FIG. 4B, a motor coil 3d is wound on each of the pole teeth 3b. Magnetic flux acting faces (outer faces) of the pole teeth 3b are opposed to the rotor magnet 8.

Further, as shown in FIGS. 2A-2D, a circular groove 2e is circularly formed in an upper end part of the step-shaped part 2d. The circular groove 2e is formed coaxially with the bearing housing 2 and circularly formed along an outer edge of the bearing housing 2. An outer wall section 2m, which acts as a retainer section, is separated, from a main body part of the bearing housing 2, by the circular groove 2e. The outer wall section 2m is plastically deformed, by heat caulking, to overlap an upper end face of the stator core 3a. Note that, the heat caulking is a caulking manner using any heating means, e.g., heat plate, ultrasonic wave means, infrared ray means, induction means. By performing the heat caulking, the heat generated by the heating means deforms the bearing housing 2 for caulking. Preferably, an axial position of a bottom part 2e1 of the circular groove 2e is equal to or lower than that of the upper end face of the stator core 3a, as shown in FIG. 1C. With this structure, when thermally caulking the outer wall section 2m, the outer wall section 2m can be plastically deformed without melting the main body part of the bearing housing 2. Therefore, the deformed outer wall section 2m overlaps the end face of the stator core 3a and retains the stator core 3a at the position. Further, since a size of the outer wall section 2m to be plastically deformed is predetermined, mountability of an insulator 3c to the stator core 3a is not lowered.

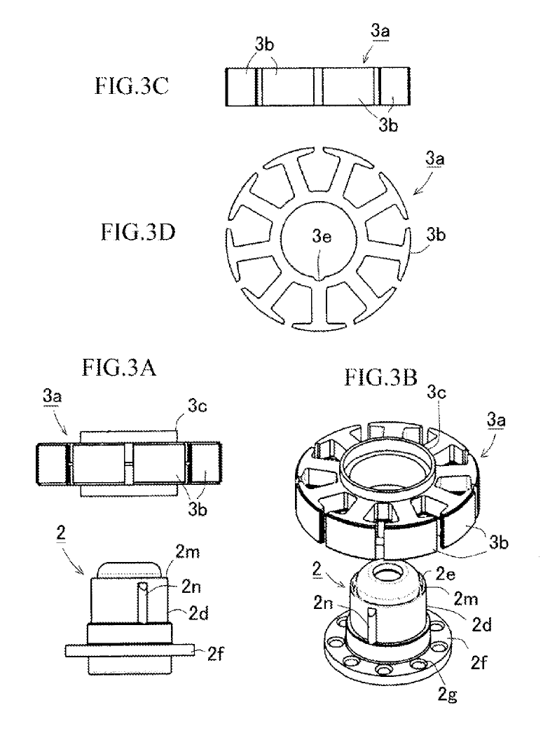

As shown in FIGS. 2A-2C, a projecting stripe 2n, which acts as a rotation stopper section, is axially formed in an outer wall face of the step-shaped part 2d. On the other hand, as shown in FIG. 3D, a recessed groove 3e is formed in an inner circumferential face of the stator core 3a. The stator core 3a is a laminated core produced by the steps of: punching, for example, electromagnetic steel plates into a prescribed shape (see FIGS. 3C and 3D); and caulking the shaped electromagnetic steel plates by a laminating press apparatus. As shown in FIGS. 3A and 3B, the stator core 3a is attached to the step-shaped part 2d by: aligning the recessed groove 3e with the projecting stripe 2n, which are formed in the outer periphery of the bearing housing 2; and fitting the projecting stripe 2n in the recessed groove 3e. With this structure, the stator core 3a can be assembled, without being press-fitted or using an adhesive, and rotation of the stator core 3a can be prohibited.

As shown in FIGS. 2A-2D, a flange 2f is formed in the outer periphery of the bearing housing 2. Flange holes 2g are formed in the flange 2f. As shown in FIG. 4B, the bearing housing 2 is fitted into a through-hole 10a of a casing 10 until the flange 2f contacts the casing 10, and screws or bosses are inserted into the flange holes 2g so as to assemble the blower to an external structure (not shown). A retaining washer 2h is fitted to an end part of the rotor shaft 5, which is fitted in the bearing section 6, and the shaft end is held by a thrust cover 2i, which is provided to the inner wall face 2b of the bearing housing 2. The thrust cover 2i has a thrust receiving member 2j composed of, for example, polyether ether ketone (PEEK). A sensor 11 for detecting positions of magnetic poles of the rotor magnet 8 of the rotor 4 is provided to the casing 10.

As shown in FIG. 1B, a plurality of retaining projections 2c (e.g., six retaining projections) are formed at one end of the housing hole located on the one end side of the bearing housing 2 and arranged in the circumferential direction. The retaining projections 2c are bent (deformed) to overlap an end face 6b of the bearing section 6 by heat caulking. By performing the heat caulking, the bearing section 6 composed of metal can be retained in the bearing housing 2 composed of resin without using an adhesive.

Successively, a method of assembling the bearing unit 1 will be explained with reference to FIGS. 1A-3D. Firstly, as shown in FIGS. 2A and 2D, the recessed groove and the projecting stripe (not shown) are aligned with each other, and then the bearing section 6 is fitted into the bearing housing 2 from the opening part 2k. Further, the bearing section 6 is further fitted into the bearing housing 2 until the bearing section 6 contacts an inner end face 21 of the housing hole, which is formed at the other end of the housing hole of the bearing housing 2. The state of completely fitting the bearing section 6 in the bearing housing 2 is shown in FIG. 1B. In this state, the bearing section 6 is attached to the bearing housing 2, and rotation of the bearing section 6 is prohibited.

Next, the retaining projections 2c (see FIG. 1B) of the bearing housing 2, which are formed at the one end of the housing hole located on the one end side of the bearing housing 2, is deformed, by heat caulking, to overlap the end face 6b of the bearing section 6 and welded thereon. In this case, the bearing section 6 can be retained in the bearing housing 2, and detachment of the bearing section 6 in the axial direction can be prevented.

Next, the stator core 3a is attached onto an outer periphery of the step-shaped part 2d of the bearing housing 2. The motor coil 3d is wound on each of the pole teeth 3b, and the surface of the stator core 3a is covered with the insulator 3c. As shown in FIGS. 3A and 3B, the stator core 3a is attached to the step-shaped part 2d in the state where the recessed groove 3e and the projecting stripe 2n formed in the outer periphery of the bearing housing 2 are aligned with and fitted to each other. Further, the stator core 3a is attached in a state where a bottom face contacts the step-shaped part 2e (see FIG. 1B). In this state, as shown in FIG. 1C, the axial position of the bottom part 2e1 of the circular groove 2e is equal to or lower than that of the upper end face of the stator core 3a.

Next, as shown in FIG. 1D, the outer wall section 2m is plastically deformed, by heat caulking, to press the upper end face the stator core 3a, so that the stator core 3a can be attached and retained. When performing the heat caulking, the bent part of the outer wall section 2m is located above the bottom part 2e1 of the circular groove 2e. Therefore, there is no possibility that the main body part of the bearing housing 2 is melted. Further, strength reduction of the bearing housing 2 can be prevented.

In a motor of the present embodiment, as shown in FIG. 3B, the bearing unit 1 is attached to the casing 10 having the sensor 11. The rotor 4, to which the impeller 9 has been attached, is assembled by the steps of: inserting the rotor shaft 5 in the bearing hole of the bearing section 6; fitting the retaining washer 2h; and fitting the thrust cover 2i on the inner circumferential face 2b of the bearing housing 2 so as to hold the shaft end of the rotor shaft 5 by the thrust receiving member 2j.

As described above, the stator core 3a is fitted to the outer wall face of the bearing housing 2 composed of resin, rotation of the stator core 3a is prohibited by the rotation stopper section, and the stator core 3a is attached in the state where the part of the outer wall section of the bearing housing 2, which acts as the retainer section, is thermally deformed to overlap the end face of the stator core 3a. Therefore, the stator core 3a can be accurately assembled, without being press-fitted into the bearing housing 2, and correctly positioned in the radial direction and the circumferential direction. Further, no strain of an outer diameter of the bearing housing 2 is generated, so that any following steps, e.g., rotary sizing step, are not required. By employing the bearing housing 2 composed of resin, the production cost of the bearing unit 1 can be reduced.

By thermally deforming the outer wall section 2m which is separated by the circular groove 2e, the main body part of the bearing housing 2 is not thermally deformed, so that strength reduction of the bearing housing 2 can be prevented and the stator core 3a can be assembled and retained at the predetermined position.

If the axial position of the bottom part 2e1 of the circular groove 2e is equal to or lower than that of the end face of the stator core 3a, the part of the outer wall section 2m can be plastically deformed without melting the main body part of the bearing housing when heat-caulking the outer wall section 2m. Therefore, the deformed part of the outer wall section 2m overlaps the end face of the stator core 3a and retains the stator core 3a at the correct position. Further, since the size of the outer wall section 2m to be plastically deformed is predetermined, mountability of the insulator 3c to the stator core 3a is not lowered.

The stator core 3a can be assembled, without press-fitting or adhering the stator core 3a to the bearing housing 2, and the rotation of the stator core 3a can be prohibited only by the steps of: aligning the projecting stripe 2n, which is formed in the outer face of the step-shaped part 2d of the bearing housing 2, with the recessed groove 3e, which is formed in the inner circumferential face of the stator core 3a; and fitting the projecting stripe 2n and the recessed groove 3e to each other.

In the motor of the present embodiment, the stator core 3a is attached on the outer circumferential face of the bearing housing 2 of the above described bearing unit 1, the bearing section 6 is attached in the bearing housing 2, and the rotor 4 is rotatably held by the bearing section 6. With this structure, the motor can be easily assembled, and the production cost thereof can be reduced.

Note that, in the present embodiment, the stator core 3a has one recessed groove 3e, and the bearing housing 2 has one projecting stripe 2n. In the present invention, a plurality of the recessed grooves 3e and a plurality of the projecting stripes 2n may be formed.

Further, the bearing section 6 fitted in the bearing housing 2 is the oil-impregnated sintered bearing, but other bearings, e.g., fluid dynamic bearing, pneumatic bearing, may be employed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alternations could be made hereto without departing from the spirit and scope of the invention.

What is claimed is:

1. A bearing unit,
comprising:
a bearing housing, which is composed of resin, being formed into a cylindrical shape and having an outer periphery, on which a stator core will be integrally attached;
a rotation stopper section being formed in an outer wall face of the bearing housing, the rotation stopper section being capable of fitting to the stator core so as to prohibit the stator core from rotating in a circumferential direction; and
a retainer section being formed in the outer wall face of the bearing housing, the retainer section being formed by thermally deforming an outer wall section of the bearing housing to overlap an end face of the stator core so as to retain the stator core.

2. The bearing unit according to claim 1,
wherein the retainer section is constituted by the outer wall section of the bearing housing, in which a concentric circular groove is formed in an outer edge part, and
the outer wall section is deformed, by heat caulking, so as to overlap the end face of the stator core.

3. The bearing unit according to claim 2,
wherein a position of a bottom part of the circular groove, in an axial direction, is equal to or lower than that of the end face of the stator core.

4. The bearing unit according to claim 1,
wherein the rotation of the stator core is prohibited by fitting a projecting stripe, which is axially formed in the outer wall section of the bearing housing, in a recessed groove, which is formed in an inner circumferential face of the stator core.

5. A motor,
comprising:
the bearing unit according to claim 1;
a stator core being attached on an outer periphery of the bearing housing;
a bearing section being attached in the bearing housing of the bearing unit; and
a rotor being rotatably held by the bearing section.
